(19) United States
(12) Patent Application Publication
(10) Pub. No.: US 2009/0044837 A1
(43) Pub. Date: Feb. 19, 2009

(54) SUBSTRATE PROCESSING APPARATUS

(75) Inventors: Hideo Tanaka, Tochigi (JP); Yukio Takabayashi, Saitama (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/246,651

(22) Filed: Oct. 7, 2008

Related U.S. Application Data
(62) Division of application No. 10/739,333, filed on Dec. 19, 2003.

(30) Foreign Application Priority Data
Dec. 24, 2002 (JP) 2002-373105

(51) Int. Cl. B08B 7/00

(52) U.S. Cl. 134/32

(57) ABSTRACT

A method includes a step of processing a substrate with a substrate processing apparatus that includes a chuck configured to hold a substrate, and a support member configured to support the chuck. A cleaning mechanism is configured to move at least one of the chuck and the support member such that the chuck and the support member move relative to each other while staying in substantial contact with each other. An additional step moves a foreign substance between protrusions on the chuck and the support member.

### FIELD OF THE INVENTION

The present invention relates to a substrate processing technique.

### BACKGROUND OF THE INVENTION

In recent years, as devices such as semiconductor devices shrink more in feature size and are highly integrated more, further increase in resolution of an exposure apparatus that transfers a pattern such as a circuit pattern in lithography is sought for. The resolution of the exposure apparatus can be increased by increasing the numerical aperture of the projection lens. When the numerical aperture increases, however, the depth of focus decreases. Hence, a substrate such as a wafer must be positioned more accurately with respect to the image surface of the projection optical system.

The substrate such as wafer is placed on a substrate chuck having a chucking mechanism. The substrate chuck is supported by a support plate mounted on a substrate table such as a 6-axis driving table. When the substrate stage is finely moved in a direction along the optical axis of the projection lens system (i.e., in the Z direction), the surface of the substrate can be aligned at the focal position of the projection system. The surface of the substrate chuck that comes into contact with the substrate has high flatness. When the substrate is chucked by the substrate chuck, its flatness is corrected.

The substrate is adversely affected by the flatness of the surface (substrate holding surface) of the substrate chuck. For example, when a foreign substance such as dust is present between the substrate and the substrate chuck that supports the substrate, the flatness of the surface of the substrate degrades. The flatness of the surface of the substrate chuck degrades when a foreign substance such as dust is present between the substrate chuck and a support plate that supports the substrate chuck. Hence, the substrate is held on the substrate chuck through point contact such that it will not be defocused during exposure, i.e., such that the adverse influence of the foreign substance is minimized. In order that the substrate chuck will not be adversely affected by the flatness of the support plate and by the foreign substance between the substrate chuck and support plate, the substrate chuck is fabricated to have high rigidity. Japanese Patent Laid-Open No. 6-196381 discloses an apparatus in which a substrate chuck is supported through point contact so that the flatness of the substrate chuck is prevented from being impaired by dust or the like in the same manner as with the substrate.

As described above, however, when the substrate chuck is imparted with high rigidity to increase the flatness of the substrate chuck, the weight of the substrate chuck increases.

The driving speed for the stage increases rapidly so that the throughput may be improved. When driving the stage, a reaction force proportional to the acceleration and weight of the stage is generated. To suppress vibration excited by the reaction force is a significant issue in the exposure apparatus that requires high accuracy. Therefore, to minimize as much as possible the reaction force occurring during stage driving that excites vibration, the weight of the movable portion is preferably minimized as much as possible. As the substrate size increases, however, the weights of the substrate chuck and stage increase more and more.

### SUMMARY OF THE INVENTION

The present invention has been made on the basis of the recognition of the above problems, and has as its object to provide a substrate processing technique that can process a substrate with high flatness while suppressing a weight of a substrate chuck.

A substrate processing apparatus according to the first aspect of the present invention comprises a support member which supports a substrate chuck, and a cleaning mechanism which moves at least one of a surface of the substrate chuck which contacts the support member and a surface of the support member which contacts the substrate chuck, and a cleaning member for the at least one, relative to each other.

One of the substrate chuck and support member preferably serves as the cleaning member for the other of the substrate chuck and support member.

The cleaning mechanism preferably includes a regulating portion which regulates movement of the substrate chuck.

The cleaning mechanism preferably includes a moving stage which moves the support member.

At least one of the substrate chuck and support member preferably has a protrusion which contacts the other of the substrate chuck and support member.

The protrusion preferably includes at least one of a pin-like structure and grid-like structure.

The apparatus preferably further comprises a fixing mechanism which fixes the substrate chuck on the support member.

The cleaning mechanism preferably includes a mechanism which moves a substrate support surface of the substrate chuck and a cleaning mechanism for the support surface relative to each other.

The apparatus preferably includes an exposure apparatus which exposes a substrate to a pattern.

A device manufacturing method according to another aspect of the present invention comprises a step of processing a substrate using a substrate processing apparatus defined in the first aspect.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1A and 1B are views schematically showing a wafer chuck and support plate in a substrate processing apparatus according to the first arrangement;

FIG. 2 is a view showing the pattern on the lower surface of the wafer chuck that partly constitutes the substrate processing apparatus;

FIG. 3 is a view showing the pattern on the upper surface of a support plate that partly constitutes the substrate processing apparatus;

FIG. 4 is a view showing the positional relationship between the pattern on the lower surface of the wafer chuck and the pattern on the upper surface of the support plate;

FIG. 5 is a view showing the schematic arrangement of an exposure apparatus according to a preferred embodiment of the present invention; and

FIG. 6 is a flow chart showing a process of manufacturing a device by utilizing the exposure apparatus.

### DETAILED DESCRIPTION OF THE PREFERRED EMBODIMENTS

The preferred embodiments of the present invention will be described with reference to the accompanying drawings.

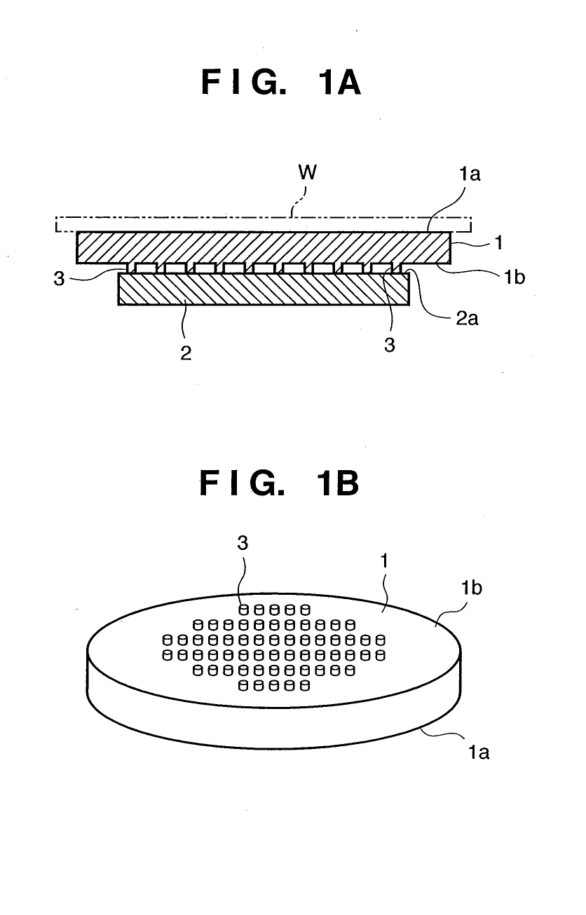

A substrate processing apparatus according to the first arrangement to which the present invention can be applied will be described. The substrate processing apparatus has a wafer chuck (substrate chuck) and a support plate which supports the wafer chuck. FIGS. 1A and 1B are views schematically showing the arrangement of the wafer chuck and support plate of the substrate processing apparatus according to the first arrangement, in which FIG. 1A is a sectional view, and FIG. 1B is a perspective view of the wafer chuck which is upside down so that the wafer chuck portion which faces the support plate faces up.

A wafer chuck 1 which chucks and supports a wafer (substrate) W is mounted on a support plate 2 and is supported by the support plate 2 from below. The wafer chuck 1 has a first surface (upper surface or substrate holding surface) 1a which faces the wafer W, and a second surface (lower surface) 1b which faces the support plate 2.

As shown in FIG. 1B, the second surface 1b of the wafer chuck 1 has a plurality of pin-like projections 3 serving as one or a plurality of protrusions. Each projection 3 has a cylindrical shape with a diameter of, e.g., 0.5 mm and a height of, e.g., 0.3 mm. The top surfaces of the plurality of projections 3 are finished to have high flatness. When the wafer chuck 1 is mounted on the support plate 2, the top surfaces of the respective projections 3 come into tight contact with a support surface 2a of the support plate 2, so that the wafer chuck 1 is supported parallel to the support surface 2a of the support plate 2.

The number of projections 3 formed on the second surface (lower surface) 1b of the wafer chuck 1 and the size of the top surfaces of the projections 3 can be determined such that when the wafer chuck 1 is mounted on the support plate 2, the wafer chuck 1 is supported parallel to the support surface 2a of the support plate 2 and that the probability that a foreign substance such as dust is caught between the projections 3 and support plate 2 falls below an allowable value. In place of forming the projections 3 on the second surface 1b of the wafer chuck 1, protruding portions similar to the projections 3 may be formed on the support surface 2a of the support plate 2. Alternatively, one or a plurality of protrusions can be formed on both the wafer chuck 1 and support plate 2.

Subsequently, how to remove the foreign substance such as dust that can be caught between the wafer chuck 1 and support plate 2, when mounting the wafer chuck 1 on the support plate 2 in the first arrangement, will be described.

According to this embodiment, while the second surface (lower surface) 1b of the wafer chuck 1 and the support surface 2a of the support plate 2 are in substantial contact with each other, the wafer chuck 1 and support plate 2 are moved relative to each other, so that the foreign substance present between the projections 3 on the second surface (lower surface) 1b of the wafer chuck 1 and the surface of the support plate 2 is moved to recesses among the projections 3 (among projections and projections) formed on the wafer chuck 1. Thus, the foreign substance that can be present between the projections 3 of the wafer chuck 1 and the surface of the support plate 2 is removed (cleaned), and the projections 3 of the wafer chuck 1 and the surface of the support plate 2 can be brought into complete contact with each other. The “substantial contact” described above includes, in addition to a state wherein the projections 3 of the wafer chuck 1 and the surface of the support plate 2 are in complete contact with each other, a state wherein a small gap, which is barely enough to allow the foreign substance between the projections 3 of the wafer chuck 1 and the support plate 2 to be moved to the recesses among the projections 3 by the relative movement of the wafer chuck 1 and support plate 2, is present between the projections 3 of the wafer chuck 1 and the support plate 2.

The relative movement of the wafer chuck 1 and support plate 2 may be caused by rotational motion such as circular motion (e.g., circular motion with a radius of about 1 mm), linear reciprocal motion, or high-frequency vibration.

With this cleaning, even when the rigidity of the wafer chuck 1 is low, the foreign substance that can be present between the projections 3 of the wafer chuck 1 and the support plate 2 can be removed, so that the flatness of the wafer chuck 1 can be increased. This moderation of the demand for the rigidity of the wafer chuck 1 contributes to weight reduction of the wafer chuck 1.

According to the above description, the wafer chuck 1 and support plate 2 are moved relative to each other. The effect of cleaning the foreign substance can be achieved also by bringing the wafer chuck 1 and/or support plate 2 into substantial contact with another member (cleaning member) and moving the wafer chuck 1 and/or support plate 2 relative to this another member (cleaning member). In this case, after the cleaning, the wafer chuck 1 must be mounted on the support plate 2, and a foreign substance can get caught between the wafer chuck 1 and support plate 2 during this mounting operation.

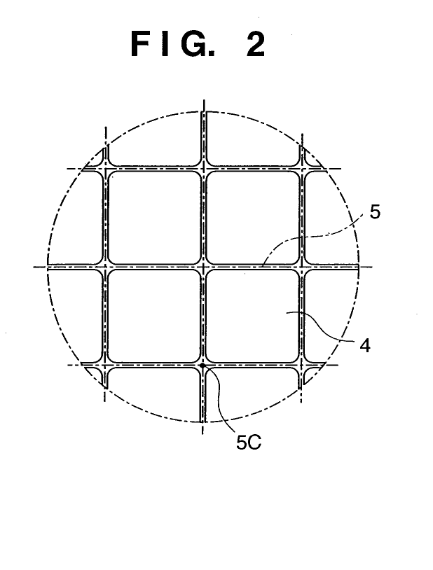

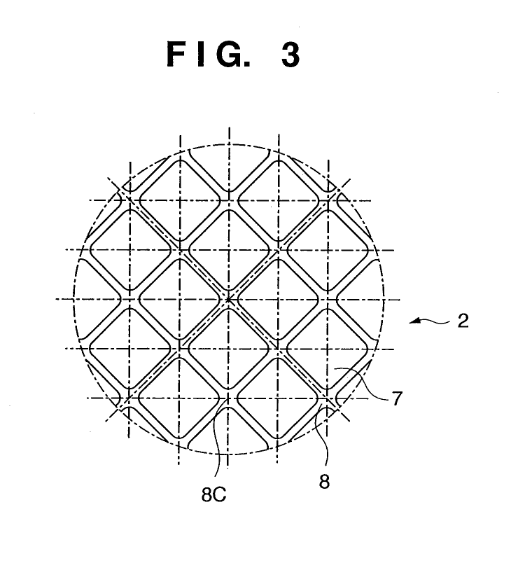

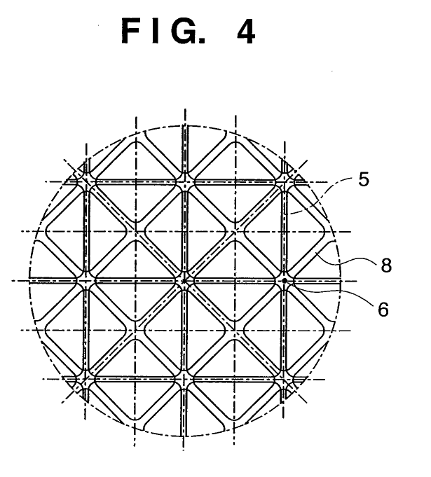

FIGS. 2 to 4 are views schematically showing the arrangement of a substrate processing apparatus according to the second arrangement. The substrate processing apparatus has a wafer chuck (substrate chuck) and a support plate. FIG. 2 shows in enlargement part of the pattern on a second surface 1b, i.e., the lower surface (a surface facing a support plate 2), of a wafer chuck 1, and FIG. 3 shows in enlargement part of the pattern on the upper surface (a support surface facing the wafer chuck 1) of the support plate 2. FIG. 4 is a view showing the positional relationship between the pattern on the second surface 1b of the wafer chuck 1 and the pattern on a support surface 2a of the support plate 2.

In the same manner as in the first arrangement, the wafer chuck 1 that chucks and holds a wafer (substrate) W is mounted on the support plate 2, and is supported by the support plate 2 from below. The wafer chuck 1 has a first surface (upper surface) 1a facing the wafer W, and the second surface (lower surface) 1b facing the support plate 2.

As shown in FIG. 2, the second surface 1b of the wafer chuck 1 has a grid-like protrusion 5 and recesses 4. The recesses 4 are recessed from the surface of the protrusion 5 by a predetermined distance (e.g., 5 mm).

As shown in FIG. 3, the support surface (upper surface) 2a of the support plate 2 has a grid-like protrusion 8 and recesses 7. The recesses 7 are recessed from the surface of the protrusion 8 by a predetermined distance (e.g., 5 mm).

In FIG. 4, the protrusions 5 and 8 are overlaid in order to show the relationship in size and position between the grid-like protrusion 5 formed on the wafer chuck 1 and the grid-like protrusion 8 formed on the support plate 2 while the wafer chuck 1 is mounted on the support plate 2. As shown in FIG. 4, the columns and rows constituting the grid-like protrusion 5 formed on the wafer chuck 1 and the columns and rows constituting the grid-like protrusion 8 formed on the support plate 2 are arranged to form an angle of 45°. Intersections (portions where the columns and rows intersect) 5C of the grid-like protrusion 5 formed on the wafer chuck 1 and intersections 8C of the grid-like protrusion 8 formed on the support plate 2 are in contact with each other. Reference numeral “6” in FIG. 4 denotes one of the contact portions of the intersections 5C of the wafer chuck 1 and the intersections 8C of the support plate 2. The area and shape of the contact portion 6 are arbitrary. In the example shown in FIG. 4, the contact portion 6 is a region of, e.g., about 1-mm square. Also, in the example shown in FIG. 4, of the wafer chuck 1, all the intersections 5C are in contact with the corresponding intersections 8C of the support plate 2. Of the support plate 2, every other intersection 8C among all the intersections 8C is in contact with the corresponding intersections 5C of the wafer chuck 1.

Subsequently, how to remove the foreign substance such as dust that can be caught between the wafer chuck 1 and support plate 2, when mounting the wafer chuck 1 on the support plate 2 in the second arrangement, will be described.

According to this embodiment, while the second surface (lower surface) 1b of the wafer chuck 1 and the support surface 2a of the support plate 2 are in substantial contact with each other, the wafer chuck 1 and support plate 2 are moved relative to each other, so that the foreign substance present on the surface of the protrusion 5 of the wafer chuck 1 and the surface of the protrusion 8 of the support plate 2 is removed to the recesses 4 of the wafer chuck 1 or the recesses 7 of the support plate 2. Thus, the foreign substance that can be present between the protrusion 5 and protrusion 8, that is, at the contact portions 6, is removed (cleaned), and the protrusion 5 and protrusion 8 can be brought into complete contact with each other. The “substantial contact” described above includes, in addition to a state wherein the protrusion 5 of the wafer chuck 1 and the protrusion 8 of the support plate 2 are in complete contact with each other, a state wherein a small gap, which is barely enough to allow the foreign substances on the protrusions 5 and 8 to be moved to the recesses 4 or 7 by the relative movement of the wafer chuck 1 and support plate 2, is present between the protrusions 5 and 8.

The relative movement of the wafer chuck 1 and support plate 2 may be caused by rotational motion such as circular motion (e.g., circular motion with a radius of about 1 mm), linear reciprocal motion, or high-frequency vibration.

With this cleaning, even when the rigidity of the wafer chuck 1 is low, the foreign substance that can be present between the protrusion 5 of the wafer chuck 1 and the protrusion 8 of the support plate 2 can be removed, so that the flatness of the wafer chuck 1 can be increased. This moderation of the demand for the rigidity of the wafer chuck 1 contributes to weight reduction of the wafer chuck 1.

According to the above description, the wafer chuck 1 and support plate 2 are moved relative to each other. The effect of cleaning the foreign substance can be achieved also by bringing the wafer chuck 1 and/or support plate 2 into substantial contact with another member (cleaning member) and moving the wafer chuck 1 and/or support plate 2 relative to this another member (cleaning member). In this case, after the cleaning, the wafer chuck 1 must be mounted on the support plate 2, and a foreign substance can get caught between the wafer chuck 1 and support plate 2 during this mounting operation.

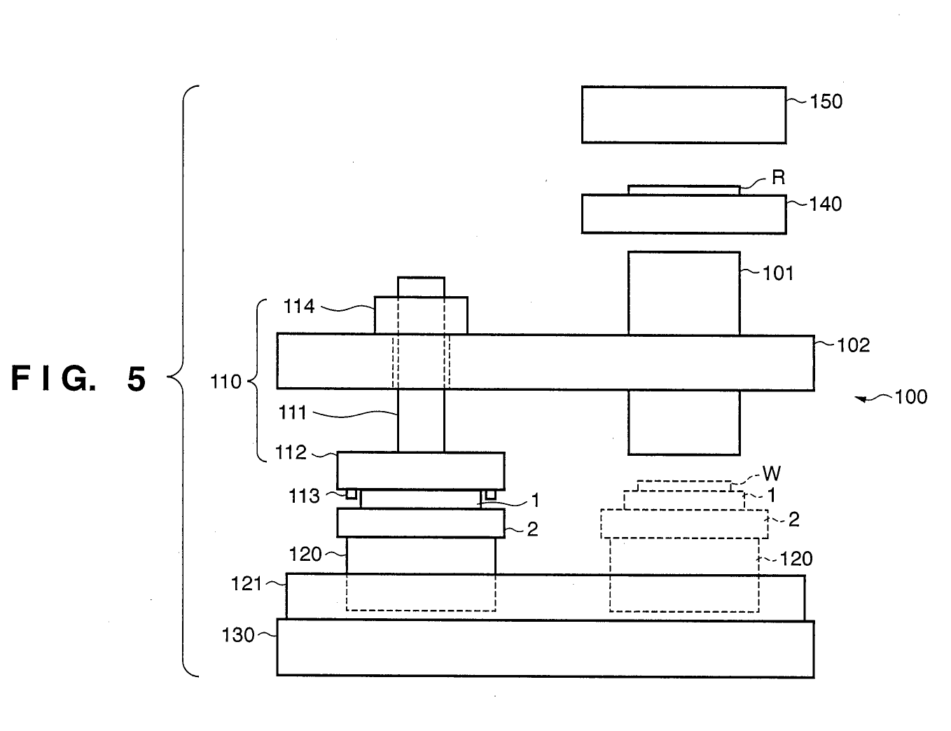

An arrangement of an exposure apparatus which incorporates a relative moving mechanism for moving the wafer chuck 1 and support plate 2 relative to each other will be described with reference to FIG. 5. This relative moving mechanism can also be grasped as a mechanism that moves the wafer chuck 1 relative to another member or a mechanism that moves the support plate 2 relative to another member.

FIG. 5 is a view showing the schematic arrangement of an exposure apparatus according to a preferred embodiment of the present invention. An exposure apparatus 100 according to the preferred embodiment of the present invention can have the same arrangement as that of a general exposure apparatus except for its relative moving mechanism. For example, the exposure apparatus 100 has a reticle stage (master stage) 140 for holding a reticle (master) R, an illumination system 150 for illuminating the reticle R, a projection system 101 for projecting the pattern of the reticle R onto a wafer (substrate) W, and a support structure 102 for supporting the projection system 101. The exposure apparatus 100 also has a wafer chuck 1 for holding the wafer W and a support plate 2 for supporting the wafer chuck 1 as the arrangement described above. The support plate 2 is mounted on, e.g., a stage 120. The stage 120 is driven in the horizontal direction (X and Y directions) on a stage surface plate 130 by an actuator (driving mechanism) 121 such as a linear motor.

According to this embodiment, the relative moving mechanism is constituted by a fixing mechanism 110 which fixes the wafer chuck 1 while cleaning is performed by relative movement, the actuator 121 for driving the stage 120, and the like.

Prior to cleaning by the relative movement, first, the stage 120 is driven horizontally to a position below the fixing mechanism 110 (note that the wafer is not placed on the wafer chuck 1). Subsequently, the fixing mechanism 110 regulates the position of the wafer chuck 1 in the horizontal direction. More specifically, an elevating mechanism 114 moves a driving shaft 111 downward, thus moving a fixing member 112 downward. For example, a regulating member 113 is provided to the fixing member 112. The regulating member 113 can regulate movement of the wafer chuck 1 in the horizontal direction. In place of or in addition to the regulating member 113, a mechanism (e.g., a vacuum suction mechanism) that chucks the wafer chuck 1 may be provided to the fixing member 112.

When the wafer chuck 1 is fixed and the wafer chuck 1 and support plate 2 are in substantial contact with each other, the actuator 121 drives the stage 120, so that the wafer chuck 1 and support plate 2 are slid or moved relative to each other. The relative movement may include rotational motion such as circular motion, reciprocal linear motion, or high-frequency vibration. With the relative movement, the foreign substance present at the contact portion of the wafer chuck 1 and support plate 2 (e.g., between projections 3 and a support surface 2a or between protrusions 5 protrusion 8) can be moved to recesses, and can be removed (cleaned).

When performing the relative movement (cleaning), a pressure may be applied to the wafer chuck 1 vertically downward through contact to urge it against the support plate 2, or the wafer chuck 1 may be urged against the support plate 2 by the weight of the wafer chuck 1. Alternatively, the wafer chuck 1 may be supported by the fixing member 112, so that the wafer chuck 1 will not be urged against the support plate 2.

The wafer chuck 1 and support plate 2 may be moved relative to each other by fixing the support plate 2 (for example, when the stage 120 is an air-floated stage, by stopping air floating) and driving the wafer chuck 1, or while driving both the wafer chuck 1 and support plate 2.

After cleaning between a second surface (lower surface) 1b of the wafer chuck 1 and the support plate 2 is completed in this manner, the wafer chuck 1 can be directly fixed at a predetermined position on the support plate 2.

Along with this cleaning of the second surface (lower surface) 1b of the wafer chuck 1, preferably, cleaning of a first surface (upper surface) 1a of the wafer chuck 1 may be performed.

For example, a wafer resist may attach to the first surface (upper surface) 1a of the wafer chuck 1. Also, a foreign substance entering from a transfer system may attach to the first surface (upper surface) 1a of the wafer chuck 1, e.g., a pin chuck, to degrade the surface accuracy of the wafer. Hence, the first surface (upper surface) 1a of the wafer chuck 1 is also preferably cleaned. This can be performed by, e.g., arranging a cleaning plate to that surface of the fixing member 112 which comes into contact with the wafer chuck 1 and moving the cleaning plate relative to the wafer chuck 1. More specifically, in the arrangement shown in FIG. 5, to clean both the first and second surfaces of the wafer chuck 1, when the first surface (upper surface) 1a of the wafer chuck 1 is to be cleaned, the regulating member 113 that has been regulating the wafer chuck 1 releases it (for example, the regulating member 113 is moved), and while the wafer chuck 1 is fixed to the support plate 2, the stage 120 (the wafer chuck 1 and support plate 2) is moved by the actuator 121. Thus, the first surface of the wafer chuck 1 can be cleaned.

In this case, a pressure may be applied to the fixing member 112 vertically downward through contact to urge the cleaning plate against the wafer chuck 1, or the cleaning plate may be urged against the wafer chuck 1 by the weight of the fixing member 112. Alternatively, the cleaning plate may not be urged against the wafer chuck 1.

Typically, upper surface cleaning of the wafer chuck 1 can be performed separately from the exposure sequence, when a foreign substance on the upper surface adversely affects the flatness of the wafer after chucking, in order to remove the resist or the like attaching to the wafer chuck 1 from the upper surface (the contact surface with the wafer) through repeated exposure sequences. Lower surface cleaning of the wafer chuck 1 can be performed when the wafer chuck 1 is removed from the support plate 2 in order to clean (e.g., ultrasonic cleaning) the wafer chuck 1, or when a new wafer chuck 1 is mounted on the support plate 2. After lower surface cleaning, the lower surface of the wafer chuck 1 will not be exposed to the atmosphere in the exposure apparatus. Thus, the lower surface of the wafer chuck 1 can be maintained in a clean state. Basically, lower surface cleaning is not necessary unless the wafer chuck 1 is removed from the support plate 2.

According to the substrate processing apparatus of the present invention, for example, the substrate can be processed with high flatness while suppressing an increase in weight of the substrate chuck.

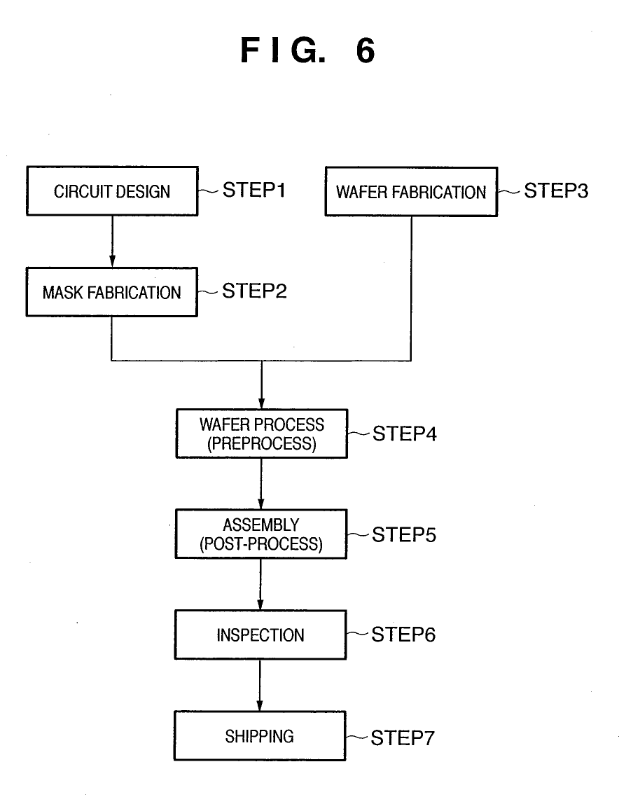

A process of manufacturing a semiconductor device as an example of a device such as a microdevice by utilizing the exposure apparatus described above will be described. FIG. 6 is a flow chart showing the flow of an overall semiconductor device manufacturing process. In step 1 (circuit design), the circuit of the semiconductor device is designed. In step 2 (mask fabrication), a mask is fabricated on the basis of the designed circuit pattern.

In step 3 (wafer manufacture), a wafer (substrate) is manufactured using a material such as silicon. In step 4 (wafer process) called a preprocess, an actual circuit is formed on the wafer by the above exposure apparatus in accordance with lithography using the prepared mask and wafer. In step 5 (assembly) called a post-process, a semiconductor chip is formed from the wafer fabricated in step 4. This step includes processes such as assembly (dicing and bonding) and packaging (chip encapsulation). In step 6 (inspection), inspections such as operation check test and durability test of the semiconductor device fabricated in step 5 are performed. A semiconductor device is completed with these processes, and is shipped in step 7.

The wafer process of step 4 has the following steps: oxidation step of oxidizing the surface of the wafer; CVD step of forming an insulating film on the wafer surface; electrode formation step of forming an electrode on the wafer by deposition; ion implantation step of implanting ions into the wafer; resist processing step of applying a photosensitive agent to the wafer; exposure step of transferring the circuit pattern to the wafer after resist processing step by the above exposure apparatus; developing step of developing the wafer exposed in the exposure step; etching step of etching portions other than the resist image developed in the developing step; and resist removal step of removing any unnecessary resist remaining after etching. By repeating these steps, a multilayered structure of circuit patterns is formed on the wafer.

As many apparently widely different embodiments of the present invention can be made without departing from the spirit and scope thereof, it is to be understood that the invention is not limited to the specific embodiments thereof except as defined in the appended claims.

1-9. (canceled)

10. A method comprising steps of:
processing a substrate with a substrate processing apparatus including a chuck configured to hold the substrate: a support member configured to support the chuck, wherein protrusions are provided on at least one of a surface of the chuck facing the support member and a surface of the support member facing the chuck; and a cleaning mechanism configured to move at least one of the chuck and the support member such that the chuck and the support member move relative to each other while the protrusions provided on at least one of the chuck and the support member stay in substantial contact with the other of the chuck and said support member; and
moving a foreign substance between the protrusions on at least one of the chuck and the support member and the other of the chuck and said support member by the cleaning mechanism to remove the foreign substance.

11. A method comprising steps of:
processing a substrate by a substrate processing apparatus including a chuck configured to hold the substrate; and a support member configured to support the chuck, wherein the chuck has a first grid shaped protrusion including columns and rows at a side facing the support member, and the support member has a second grid shaped protrusion including columns and rows at a side facing the chuck; and a cleaning mechanism configured to spatially shift the first grid shaped protrusion relative to the second grid shaped protrusion while a part of the columns and rows of the first grid shaped protrusion and a part of the columns and rows of the second grid shaped protrusion are in substantial contact with each other; and
moving a foreign substance between the first grid shaped protrusion and the second grid shaped protrusion by the cleaning mechanism to remove the foreign substance.

12. A method comprising steps of:
processing a substrate with a substrate processing apparatus including a chuck configured to hold a substrate; a support member configured to support the chuck, wherein the chuck has a first grid shaped protrusion at a side facing the support member, and the support member has a second grid shaped protrusion at a side facing the chuck; and a cleaning mechanism configured to spatially shift the first grid shaped protrusion relative to the second grid shaped protrusion while the first grid shaped protrusion and the second grid shaped protrusion are in substantial contact with each other; and
moving a foreign substance between the first grid shaped protrusion and the second grid shaped protrusion by the cleaning mechanism to remove the foreign substance.

13. A method comprising steps of:
processing a substrate with a substrate processing apparatus including a chuck configured to hold a substrate; a support member configured to support the chuck, wherein protrusions are provided on at least one of a surface of the chuck facing the support member and a surface of the support member facing the chuck; and a cleaning mechanism including a regulating portion configured to regulate movement of the chuck and a driving mechanism configured to horizontally drive the support member, wherein the cleaning mechanism is configured to regulate movement of the chuck by the regulating portion and to horizontally move the support member by the driving mechanism while the protrusions provided on at least one of the chuck and the support member stay in substantial contact with the other of the chuck and the support member; and
regulating the movement of the chuck by the regulating portion and horizontally driving the support member by the driving mechanism while the protrusions provided on at least one of the chuck and the support member stay in substantial contact with the other of the chuck and the support member to remove a foreign substance between the protrusions provided on at least one of the chuck and the support member and the other of the chuck and the support member.
